(19) United States
(12) Patent Application Publication
(10) Pub. No.: US 2025/0389684 A1
(43) Pub. Date: Dec. 25, 2025

(54) SENSOR AND DETECTION METHOD

(71) Applicant: Murata Manufacturing Co., Ltd., Nagaokakyo-shi (JP)

(72) Inventors: Shota USHIBA, Nagaokakyo-shi (JP); Tomomi NAKANO, Nagaokakyo-shi (JP); Ayumi SHINAGAWA, Nagaokakyo-shi (JP); Naruto MIYAKAWA, Nagaokakyo-shi (JP); Shinsuke TANI, Nagaokakyo-shi (JP)

(73) Assignee: Murata Manufacturing Co., Ltd., Nagaokakyo-shi (JP)

(21) Appl. No.: 19/312,359

(22) Filed: Aug. 28, 2025

Related U.S. Application Data
(63) Continuation of application No. PCT/JP2024/006741, filed on Feb. 26, 2024.

(30) Foreign Application Priority Data
Mar. 2, 2023 (JP) 2023-031968

(51) Int. Cl. G01N 27/07

(52) U.S. Cl. CPC G01N 27/07

(57) ABSTRACT

A sensor for detecting a substance to be detected in a solution includes a field effect transistor-type sensor element and probe molecules and positively charged molecules arranged on at least a portion of the surface of the sensor element. The positively charged molecules have a cationic functional group the charge state of which has no pH dependence.

### CROSS-REFERENCE TO RELATED APPLICATIONS

The present application is a continuation of International Application No. PCT/JP2024/006741, filed Feb. 26, 2024, which claims priority to Japanese patent application 2023-031968, filed Mar. 2, 2023, the entire contents of each of which being incorporated herein by reference.

### TECHNICAL FIELD

The present disclosure relates to a sensor such as a biosensor or the like. The present disclosure further relates to a detection method using the sensor.

### BACKGROUND ART

A field effect transistor (FET: Field Effect Transistor)-type sensor using probe molecules, specifically interacting with target molecules, is known as a sensor for detecting a substance to be detected (also referred to as “target molecules”) in a solution. In such a FET-type sensor, probe molecules are arranged on the surface of a sensor element.

An example of FET constituting the FET-type sensor is graphene FET using graphene as a channel formed between a source electrode and a drain electrode. The graphene is a two-dimensional material composed of carbon atoms bonded in a hexagonal network. The graphene has a very large specific surface area (surface area per volume) and very high electric mobility. Therefore, in the graphene FET, the charge of a graphene molecule is easily converted to a current signal.

In general, the zeta potential of graphene has a negative value. That is, the surface of graphene is negatively charged. Also, many of the biomolecules used as target molecules of a biosensor are negatively charged. Therefore, when target molecules in a solution are detected by using a graphene FET-type biosensor, the negatively charged target molecules are detected by the negatively charged surface of the sensor element.

Non Patent Document 1 includes no description about graphene FET, but discloses that when the negatively charged surface of a FET biosensor causes a decrease in sensor sensitivity. Specifically, Non Patent Document 1 describes that the total surface charge is adjusted by depositing positively or negatively charged blocker molecules together with probe molecules on a negatively charged SiO₂ surface, and the charge of the whole, including the target molecules, is adjusted near zero, thereby improving sensor sensitivity.

In view of the description of Non Patent Document 1, it is considered that in a graphene FET-type biosensor including a channel constituted by graphene having a negatively charged surface, the negative surface charge of a sensor element is relieved by arranging molecules which are positively charged (also referred to as “positively charged molecules” hereinafter) on the surface of the sensor element, thereby increasing sensor sensitivity.

Non Patent Document 2 discloses a graphene FET biosensor modified with poly-L-lysine. Non Patent Document 2 describes poly-L-lysine as a linker for modifying DNA serving as probe molecules, but neither discloses nor suggests that the total surface charge is adjusted by modifying with poly-L-lysine. However, it is well known that the zeta potential of ply-L-lysine has a positive value, and thus in Non Patent Document 2, the effect of increasing sensitivity is considered to be exhibited by relieving the negative surface charge.

Also, Patent Document 1 discloses, as reference information related to Non Patent Document 2, a device for detecting or measuring target marker molecules in a body fluid-derived sample, the device including a support for capturing the body fluid-derived sample and a semiconductor sensor which detects or measures a pH change or optical change caused by an identification material which specifically recognizes the target marker molecules in the body fluid-derived sample. Patent Document 1 describes that various modifications may be made to the surface of the support in order to capture the body fluid-derived sample such as cells, vesicles, or the like, and a cationic polymer such as poly-L-lysine or the like is given as an example.

### CITATION LIST

### Patent Document

Patent Document 1: International Publication No. WO 2021/220928

### Non Patent Documents

Non Patent Document 1: M. Gupta et al., “Surface Charge Modulation and Reduction of Non-Linear Electrolytic Screening in FET-Based Biosensing”, IEEE Sensors Journal, 21, 4143 (2021)
Non Patent Document 2: J. Gao et al., “Poly-L-Lysine-Modified Graphene Field-Effect Transistor Biosensors for Ultrasensitive Breast Cancer miRNAs and SARS-COV-2 RNA Detection”, Anal. Chem., 94, 1626 (2022).

### SUMMARY

### Technical Problems

Non Patent Document 1 describes that in order to adjust the surface charge, blocker molecules having a positive charge (—NH₂ terminal) or negative charge (—COOH terminal) are deposited together with probe molecules on the surface of a sensor element. Specifically, Non Patent Document 1 describes that a self-assembled monolayer (SAM) of N₃-silane is vapor-deposited on the surface of a sensor element by chemical vapor deposition, and then peptide nucleic acid (PNA) coupled with bibenzocyclooctyne (DBCO)), containing a blocker molecule, is reacted with azide terminals of SAM and thus immobilized on the surface.

In Non Patent Document 1, positively charged molecules or negatively charged molecules for modulating the zeta potential are arranged on the surface of the sensor element by covalent bonds using a silane coupling agent. However, this method can be used only for the surface of an oxide such as SiO₂ or the like, but cannot be used for graphene FET. This is because when positively charged molecules are arranged on the surface of the sensor element by covalent bonds, it is necessary to arrange the molecules while breaking the bond of graphene, thereby damaging the high functionality of graphene.

On the other hand, Non Patent Document 2 describes a graphene FET biosensor modified with positively charged poly-L-lysine. However, it is found that when target molecules in a solution are detected by operating the sensor described in Non Patent Document 2 in the solution, there occurs the problem of decreasing FET response depending on the type of the solution used.

In addition, the problem described above is not limited to the graphene FET-type biosensor and is considered as a problem occurring generally in FET-type sensors.

The present disclosure is achieved for solving the problem, and directed to providing a sensor capable of detecting a substance to be detected in a solution with high sensitivity and a detection method using the sensor.

### Solutions to Problems

A sensor for detecting a substance to be detected in a solution includes a field effect transistor-type sensor element and probe molecules and positively charged molecules arranged on at least a portion of the surface of the sensor element, and the positively charged molecules having a cationic functional group the charge state of which has no pH dependence.

In a first embodiment, a detection method includes a step of capturing a substance to be detected in a solution by probe molecules using the sensor of the present disclosure, and a step of measuring an electrical change caused by the substance to be detected in the sensor element.

In a second embodiment, a detection method includes a step of capturing a substance to be detected in a solution by the probe molecules using the sensor of the present disclosure, a step of measuring an electrical change caused by the substance to be detected in each of a first sensor element and a second sensor element, and a step of comparing the electrical change of the first sensor element with the electrical change of the second sensor element.

### Advantageous Effects

The present disclosure can provide a sensor capable of detecting a substance to be detected in a solution with high sensitivity. Further, the present disclosure can provide a detection method using the sensor.

### BRIEF DESCRIPTION OF DRAWINGS

FIG. 1 is a schematic diagram showing an example of a sensor according to a first embodiment.

FIG. 2 is a graph for explaining the pH dependence of the valence of a functional group.

FIG. 3 is a schematic diagram schematically showing an example of the usage state of the sensor shown in FIG. 1.

FIG. 4 is a graph showing a relation between gate voltage VG and source-drain current IDs.

FIG. 5 is a schematic diagram showing an example of a sensor according to a second embodiment.

FIG. 6A is a schematic diagram showing an example of a state where few positively charged molecules are arranged on the surface of a sensor element. FIG. 6B is a schematic diagram showing an example of a state where many positively charged molecules are arranged on the surface of a sensor element.

FIG. 7A is a schematic diagram showing an example of a state where a negatively charged blocking agent is arranged on the surface of the sensor element shown in FIG. 6A. FIG. 7B is a schematic diagram showing an example of a state where a negatively charged blocking agent is arranged on the surface of the sensor element shown in FIG. 6B.

FIG. 8A is a schematic diagram showing an example of a state where a positively charged blocking agent is arranged on the surface of the sensor element shown in FIG. 6A. FIG. 8B is a schematic diagram showing an example of a state where a positively charged blocking agent is arranged on the surface of the sensor element shown in FIG. 6B.

FIG. 9 is a schematic diagram showing an example of a sensor according to a third embodiment.

FIG. 10 is a schematic diagram showing an example of a sensor according to a fourth embodiment.

FIG. 11 is a schematic diagram showing a first modified example of the sensor according to the fourth embodiment.

FIG. 12 is a schematic diagram showing a second modified example of the sensor according to the fourth embodiment.

FIG. 13 is a schematic diagram showing a third modified example of the sensor according to the fourth embodiment.

FIG. 14 is a schematic diagram showing an example of a sensor element formed on an insulating substrate.

FIG. 15 is a schematic diagram showing an example of positively charged molecules.

FIG. 16 is a schematic diagram showing an example of prove molecules present together with positively charged molecules.

FIG. 17 is a schematic diagram showing an example of a first sensor element on whose surface probe molecules and positively charged molecules are arranged.

FIG. 18 is a schematic diagram showing another example of a first sensor element on whose surface probe molecules and positively charged molecules are arranged.

FIG. 19 is a schematic diagram showing an example of a first sensor element on whose surface a blocking agent is arranged.

FIG. 20 is a schematic diagram showing another example of a first sensor element on whose surface a blocking agent is arranged.

FIG. 21 is a schematic diagram showing an example of a second sensor element on whose surface a blocking agent is arranged.

FIG. 22 is a graph showing an example of detection results with only a first sensor element used.

FIG. 23 is a graph showing an example of detection results with a first sensor element and second sensor element used.

FIG. 24 is a schematic diagram showing an example of a third sensor element on whose surface positively charged molecules 30 are not arranged.

FIG. 25 is a graph showing an example of detection results with a third sensor element and second sensor element used.

### DESCRIPTION OF EMBODIMENTS

A sensor and detection method of the present disclosure are described below. However, the present disclosure is not limited to embodiments described below, and proper modification can be applied within a range not changing the scope of the present invention. The present disclosure includes a combination of two or more configurations of the present disclosure described in the embodiments below.

A sensor of the present disclosure is a sensor for detecting a substance to be detected in a solution. The sensor of the present disclosure is, for example, a FET-type biosensor. In the FET-type biosensor, a mechanism modeled on a biological body is formed in a channel portion, and the reaction occurring in the portion is detected by electric characteristics of FET. The sensor of the present disclosure may be applied to a sensor other than the biosensor.

Each of the embodiments described below is an example, and of course, partial replacement or combination of the configurations described in the different embodiments can be made. In a second or subsequent embodiment, description of a matter common with a first embodiment is not repeated, and only different points are described. In particular, the similar function effects of similar configurations are not sequentially described in the respective embodiments.

### First Embodiment

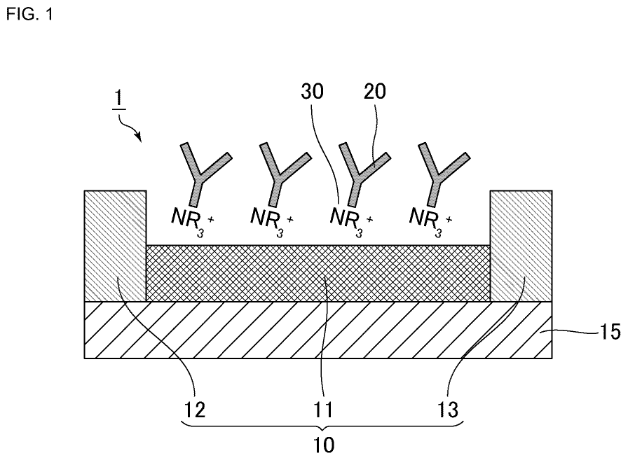

FIG. 1 is a schematic diagram showing an example of a sensor according to a first embodiment.

In FIG. 1, the configuration of the sensor is properly changed for clarifying and simplifying the drawing. The same is true in the other drawings. In the drawings, the same or equivalent portions are denoted by the same reference numeral. In the drawings, the same element is denoted by the same reference numeral, and duplicate description is not repeated.

A sensor 1 shown in FIG. 1 includes a field effect transistor-type sensor element 10 and probe molecules 20 and positively charged molecules 30 which are arranged on at least a portion of the surface of the sensor element 10.

The sensor element 10 includes, for example, a semiconductor layer 11, and a source electrode 12 and a drain electrode 13 which are electrically connected to the semiconductor layer 11. The semiconductor layer 11 between the source electrode 12 and the drain electrode 13 constitutes a channel of the sensor element 10.

In the example shown in FIG. 1, the probe molecules 20 and the positively charged molecules 30 are arranged on at least a portion of the surface of the semiconductor layer 11.

The sensor 1 may further include an insulating substrate 15. In this case, the sensor element 10 is arranged on the insulating substrate 15.

In the example shown in FIG. 1, the source electrode 12 and the drain electrode 13 are arranged to be separated from each other on the insulating substrate 15. The insulating substrate 15 is exposed between the source electrode 12 and the drain electrode 13. The semiconductor layer 11 is arranged on the insulating substrate 15 so as to cover the exposed portion of the insulating substrate 15. The semiconductor layer 11 may be arranged on the insulating substrate 15 so as to cover the end portion of the source electrode 12, the exposed portion of the insulating substrate 15, and the end portion of the drain electrode 13.

The sensor element 10 may contain graphene or carbon nanotubes. Specifically, the semiconductor layer 11 may contain graphene or carbon nanotubes. The use of a FET-type transistor containing graphene or carbon nanotubes as a channel can increase the sensitivity of a sensor.

The graphene is a two-dimensional material composite of carbon atoms bonded in a hexagonal network. The graphene has a very large specific surface area (surface area per volume) and very high electric mobility.

In general, the graphene represents a carbon-based sheet-shaped material having a single carbon atom layer with a honeycomb structure. However, in the present specification, the following materials are widely defined as “graphene”.
Carbon-based sheet material containing graphene multilayered up to 100 layers or partially multilayered
Carbon-based sheet material composed of a polycrystal having grain boundaries and end portions caused by partial breakage.
Carbon-based sheet material in which elements are partially substituted or a honeycomb structure is collapsed
Graphene oxide and reduced graphene oxide produced by reducing the oxide
Ribbon-shaped (strip-shaped) graphene
Carbon nanotubes made of cylindrical sheet-shaped graphene and a round-shaped graphene material

The carbon nanotubes are a carbon compound having a long cylindrical shape. For example, single wall carbon nanotubes (SW-CNT) having a single carbon layer with the same network structure as graphene can be used as the carbon nanotubes.

The number of semiconductor layers 11 is not limited to 1 and may be 2 or 3. The number of the semiconductor layer 11 may be 10 or less, e.g., 5 or less. The number of semiconductor layers 11 may not be constant over the whole of the semiconductor layers 11, and for example, a portion having a single layer and a portion having two or more layers may be mixed. The number of the semiconductor layers 11 can be measured by, for example, Raman spectroscopy or observation of a section with a transmission electron microscope (TEM).

The source electrode 12 and the drain electrode 13 are, for example, electrodes with a multilayer structure formed by laminating a titanium (Ti) layer and a gold (Au) layer. Besides titanium and gold, an electrode material such as a metal, such as gold, platinum, titanium, palladium, or the like, may be used for a single layer, or two or more metals may be used in combination for a multilayer structure.

Examples of the insulating substrate 15 include a thermal silicon oxide substrate having a silicon oxide (SiO₂) layer formed by oxidizing the surface of a silicon (Si) substrate, a boron nitride (BN) substrate, and the like. Examples of a material used for forming the insulating substrate 15 include, but are not particularly limited to, inorganic compounds such as silicon oxide, silicon nitride, aluminum oxide, titanium oxide, calcium fluoride, and the like; organic compounds such as an acrylic resin, polyimide, a fluororesin, and the like; and the like. The shape of the insulating substrate 15 is not particularly limited and may be a flat plate shape or a curved plate shape. The insulating substrate 15 may have flexibility.

Examples of the probe molecules 20 arranged on the surface of the sensor element 10 include an antibody, an enzyme, a saccharide, an aptamer (nucleic acid), lectin, oligonucleotide, peptide, a low-molecular organic polymer, and the like. Among these, at least one selected from the group including an antibody, an enzyme, peptide, and lectin may be used.

The probe molecules 20 may be movable with a certain degree of freedom as long as they stay on the surface of the sensor element 10. The probe molecules 20 may be arranged directly or indirectly on the surface of the sensor element 10. For example, the probe molecules 20 may be modified with the positively charged molecules 30.

The positively charged molecules 30 arranged on the surface of the sensor element 10 are positively charged. The positively charged molecules 30 have a cationic functional group the charge state of which has no pH dependence. FIG. 1 shows an example in which the cationic functional group of the positively charged molecules 30 is a NR₃⁺ group (trialkylammonium group). The sentence “the positively charged molecules 30 are arranged on the surface of the sensor element 10” includes not only a case where molecules having a cationic functional group such as a NR₃⁺ group or the like are arranged on the surface of the sensor element 10, but also a case where cationic functional groups such as a NR₃⁺ group or the like are arranged on the surface of the sensor element 10 as shown in FIG. 1. In other words, the arrangement of “positively charged molecules 30” on the surface of the sensor element 10 encompasses scenarios where molecules possessing cationic functional groups, such as an NR₃⁺ group, are disposed on the surface, as depicted in FIG. 1.

In the present specification, the sentence “the charge state has no pH dependence” represents that the charge state is not changed with pH, more specifically the charge state is not changed within a range in which the pH of the measurement solution is 2 or more and 12 or less. In other words, the charge state is not changed within a typical operating range for biological solutions, for example, where the pH is between 2 and 12.

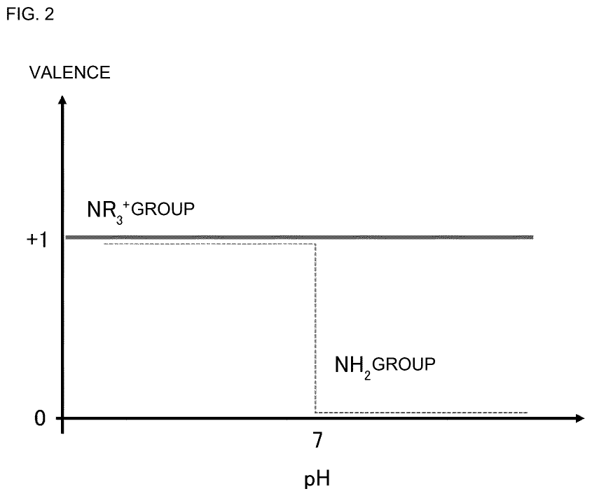

FIG. 2 is a graph for explaining the pH dependence of functional group valence.

As shown in FIG. 2, in principle, the valence of a NR₃⁺ group is constant at +1 regardless of the pH of the solution. That is, the charge state of the NR₃⁺ group has no pH dependence. On the other hand, the valence of a NH₂⁺ group is changed from +1 to 0 depending on pH. That is, the charge state of the NH₂ group has pH dependence. In the example shown in FIG. 2, the valence of the NH₂ group is changed from pH=7, but the pH at which the valence is changed is not limited to 7.

It is generally known that FET response on the charge of a protein is deceased on the surface of a sensor element having high pH response (refer to, for example, Narendra Kumar et al., J. Electrochem. Soc. 164, B409 (2017) et.). Therefore, it is considered that when positively charged molecules having a cationic functional group (NH₂ group), the charge state of which has pH response, are arranged on the surface of a sensor element, the negative surface charge of the sensor element can be relieved, but the sensor sensitivity is decreased due to an increase in pH response. For example, poly-L-lysine described in Non Patent Document 2 has a NH₂ group, and thus the sensor sensitivity is considered to be decreased.

On the other hand, when positively charged molecules having a cationic functional group, the charge state of which has no pH response, are arranged on the surface of a sensor element, the negative surface charge of the sensor element can be relieved, and the surface having low pH response can be realized. As a result, target molecules such as biomolecules and the like can be detected with high sensitivity.

In particular, when the sensor element 10 contains graphene, specifically when the semiconductor layer 11 contains graphene, graphene FET has a film surface having small pH response as compared with silicon FET and the like. Therefore, the effect of the cationic functional group, the charge state of which has no pH response, can be easily obtained, and thus the sensitivity can be further increased. The same is true for when the sensor element 10 (specifically, the semiconductor layer 11) contains carbon nanotubes.

The positively charged molecules 30 may be movable with a certain degree of freedom as long as they stay on the surface of the sensor element 10. The positively charged molecules 30 may be arranged directly or indirectly on the surface of the sensor element 10.

Examples of the cationic functional group possessed by the positively charged molecules 30 include a NR₃⁺ group (Rs each independently represent an alkyl group or aryl group having 1 or more and 20 or less carbon atoms). The NR₃⁺ group may be one type or two or more types. As described above, the charge state of the NR₃⁺ group is not changed with a pH change. Therefore, the sensor surface having small pH response can be realized. In particular, when the sensor element 10 (specifically the semiconductor layer 11) contains graphene or carbon nanotubes, the positively charged molecules 30 can be arranged by using non-covalent bonds (electrostatic interaction or cation-n interaction) on the surface of the sensor element 10 without damaging the high sensitivity characteristic of graphene or carbon nanotubes. This use of such non-covalent bonds may be particularly advantageous for graphene-based sensors, as it avoids introducing defects into the graphene lattice that would occur with covalent bonding, thereby preserving the material's superior electronic properties.

Alternatively, the cationic functional group possessed by the positively charged molecules 30 contains, for example, a PR₃⁺ group (Rs each independently represent an alkyl group or aryl group having 1 or more and 20 or less carbon atoms). The PR₃⁺ group may be one type or two or more types. The charge state of PR₃⁺ group is not changed with a pH change, and thus the same effect as the NR₃⁺ group can be obtained.

In the NR₃⁺ group or PR₃⁺ group, Rs each independently represent an alkyl group or aryl group having 1 or more and 20 or less carbon atoms. An aryl group is a functional group not containing a heteroatom and specifically represents an unsubstituted phenyl group or a substituted phenyl group. When the number of carbon atoms of an alkyl group or aryl group as R exceeds 20, the hydrophilicity of the positively charged molecules 30 is lost, and thus this is undesired. From the viewpoint of water solubility, Rs in the NR₃⁺ group or PR₃⁺ group may each independently be an alkyl group or aryl group having 1 or more and 6 or less carbon atoms.

When Rs in the NR₃⁺ group or PR₃⁺ group each have a small number of carbon atoms, the hydrophilicity of the positively charged molecules 30 is easily increased. Therefore, at least one R in the NR₃⁺ group or PR₃⁺ group may be a methyl group. In the NR₃⁺ group or PR₃⁺ group, at least two Rs may be methyl groups, or three Rs may be methyl groups.

The cationic functional group such as the NR₃⁺ group, PR₃⁺ group, or the like may be arranged on the surface of the sensor element 10 with a surface density of 5×10⁻² C/m² or less. When the surface density of the cationic functional group is 5×10⁻² C/m² or less, the cationic functional group is hardly stacked on the surface of the sensor element 10. In this case, the capturing positions of the target molecules becomes¥ closer to the surface of the sensor element 10, and thus sensitivity is hardly decreased.

The surface density of the cationic functional group is not particularly limited as long as it is equivalent to or higher than the detection limit, but is, for example, 1×10⁻⁵ C/m² or more.

The surface density of the cationic functional group can be analyzed by, for example, Raman spectroscopy or Fourier transform infrared (FT-IR) spectroscopy.

The sensor 1 shown in FIG. 1 may further include a gate electrode for applying an electric field from the outside to the semiconductor layer 11 of the sensor element 10.

The sensor 1 shown in FIG. 1 is operated in a liquid. In this case, a site which can be bonded to the substance to be detected is present on the liquid-contact surface of the sensor element 10.

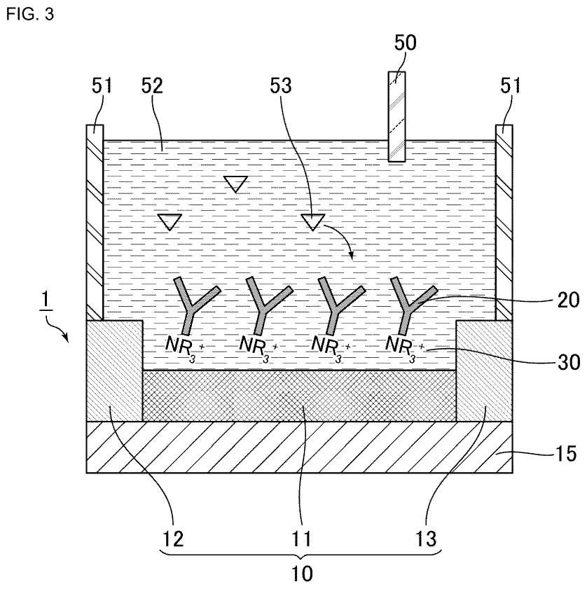

FIG. 3 is a schematic diagram schematically showing an example of the usage state of the sensor shown in FIG. 1.

The example shown in FIG. 3 has a configuration in which for example, a silicone rubber-made pool 51 is provided on the sensor 1, and the inside of the pool 51 is filled with an electrolytic solution 52. A gate electrode 50 is immersed in the electrolytic solution 52, and a bipotentiostat (not shown) is connected to the source electrode 12, the drain electrode 13, and the gate electrode 50. The electrolytic solution 52 contains a substance to be detected (target molecules) 53.

The gate electrode 50 is used for applying a potential to the source electrode 12 and the drain electrode 13, and a noble metal is generally used. The gate electrode 50 is disposed at a position other than the respective positions where the source electrode 12 and the drain electrode 13 are formed. The gate electrode 50 is generally disposed on the insulating substrate 15 or a place other than the insulating substrate 15, but may be disposed above the source electrode 12 or the drain electrode 13.

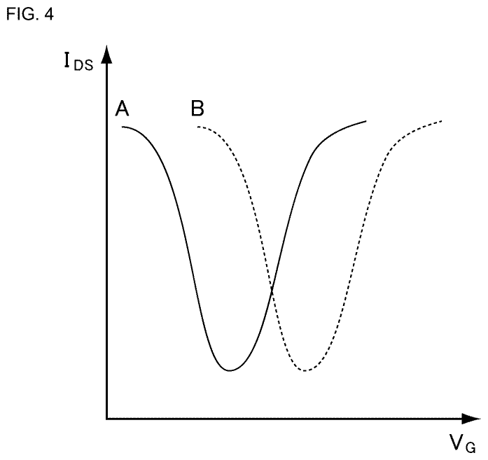

FIG. 4 is a graph showing the relation between gate voltage Ve and source-drain current IDs.

In FIG. 4, the source-drain current IDs when the probe molecules are not bonded to the substance to be detected is shown by solid line A, and the source-drain current Ips when the probe molecules are bonded to the substance to be detected is shown by broken line B. As shown in FIG. 4, when the probe molecules are specifically bonded to the substance to be detected, the conductive characteristics are modulated by the charge of the target molecules serving as the substance to be detected. The observation of the modulation enables sensing of the presence or concentration of the substance to be detected.

### Second Embodiment

A sensor according to a second embodiment includes a sensor element in which a blocking agent is arranged together with probe molecules and positively charged molecules on at least a portion of the surface thereof.

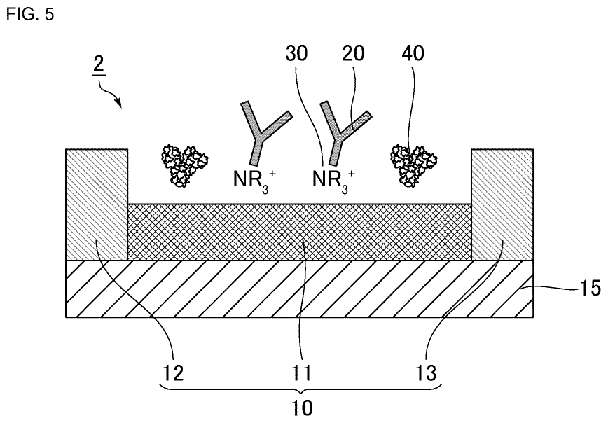

FIG. 5 is a schematic diagram showing an example of the sensor according to the second embodiment.

In a sensor 2 shown in FIG. 5, a blocking agent 40 is arranged together with probe molecules 20 and positively charged molecules 30 on at least a portion of the surface includes a sensor element 10.

As shown in FIG. 5, the blocking agent 40 is adsorbed in a gap between the adjacent probe molecules 20. Therefore, the surfaces of the probe molecules 20 or the positively charged molecules 30 are not covered with the blacking agent 40.

Examples of the blocking agent 40 include proteins (for example, bovine serum albumin (BSA), hemoglobin, skim milk, and the like), surfactants (for example, Tween (product name), Triton (product name), sodium dodecyl sulfate (SDS), and the like), and polymers (for example, PEG, PVP, and the like). These may be used alone or as a mixture of two or more. The blocking agent 40 may be either negatively charged or positively charged.

When the blocking agent 40 is arranged on the surface of the sensor element 10, non-specific adsorption can be suppressed, thereby increasing the accuracy of the sensor 2.

Also, as described below, variation in charge on the surface of the sensor element 10 can be adjusted by the blocking agent 40, thereby increasing the accuracy of the sensor 2.

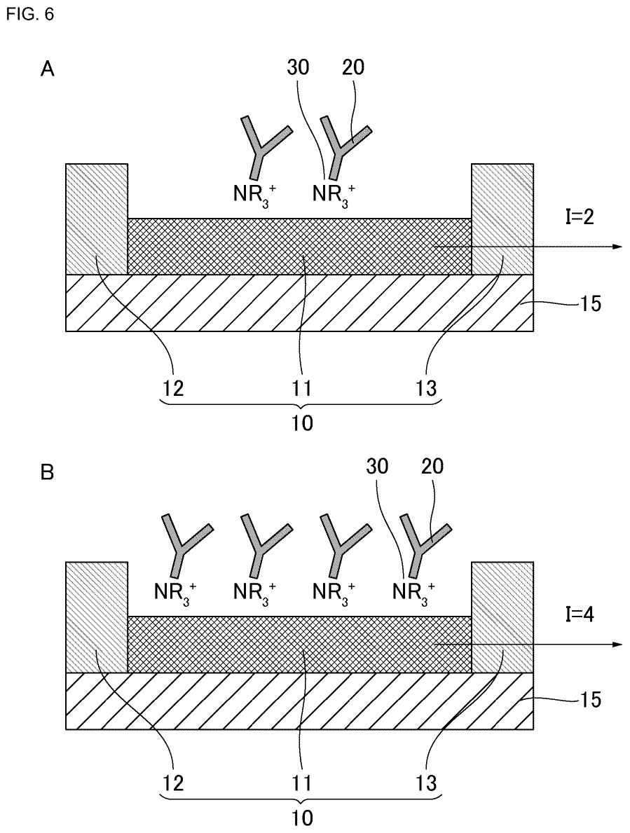

FIG. 6A is a schematic diagram showing an example of a state in which few positively charged molecules are arranged on the surface of the sensor element. FIG. 6B is a schematic diagram showing an example of a state in which many positively charged molecules are arranged on the surface of the sensor element.

In FIG. 6A and FIG. 6B, the value of current flowing through the semiconductor layer 11 of the sensor element is determined by a total of micro surface charge states. Therefore, when few positively charged molecules 30 are arranged on the surface of the sensor element 10 as shown in FIG. 6A, the current value becomes small, while when many positively charged molecules 30 are arranged on the surface of the sensor element 10 as shown in FIG. 6B, the current value becomes large. For example, the current value in FIG. 6A is I=2, while the current value in FIG. 6B is I=4.

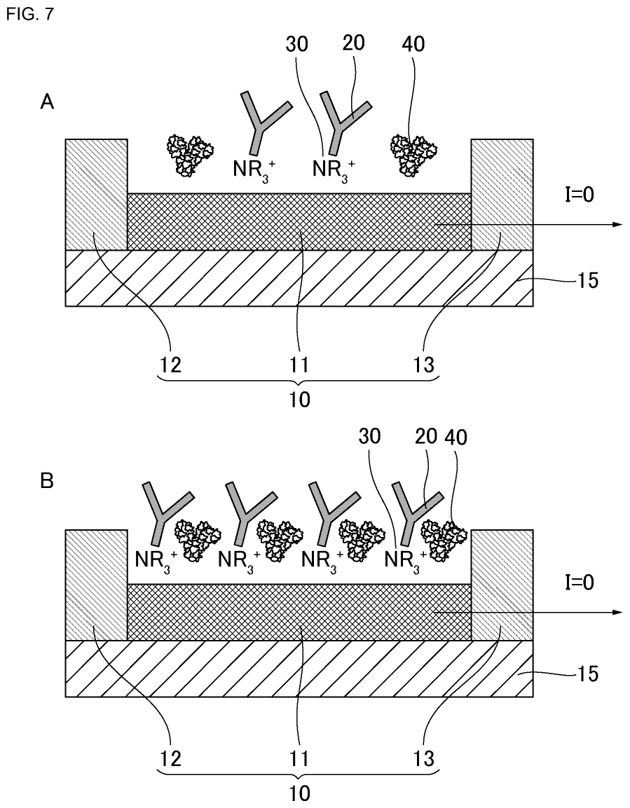

FIG. 7A is a schematic diagram showing an example of a state in which a negatively charge blocking agent is arranged on the surface of the sensor element shown in FIG. 6A. FIG. 7B is a schematic diagram showing an example of a state in which a negatively charged blocking agent is arranged on the surface of the sensor element shown in FIG. 6B.

When the blocking agent 40 is negatively charged, a small amount of negatively charged blocking agent 40 is adsorbed on the surface of the sensor element 10 on which few positively charged molecules 30 are arranged as shown in FIG. 7A, while a large amount of negatively charged blocking agent 40 is adsorbed on the surface of the sensor element 10 on which many positively charged molecules 30 are arranged as shown in FIG. 7B. Therefore, the value of current flowing through the semiconductor layer 11 of the sensor element 10 is equalized. For example, the current value in FIG. 7A can be adjusted to I=0, while the current value in FIG. 7B can be adjusted to I=0.

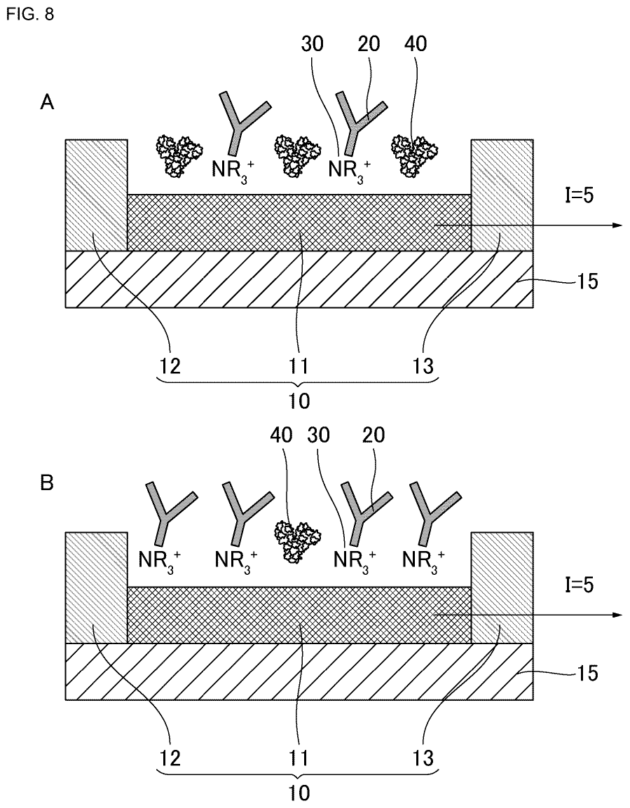

FIG. 8A is a schematic diagram showing an example of a state in which a positively charge blocking agent is arranged on the surface of the sensor element shown in FIG. 6A. FIG. 8B is a schematic diagram showing an example of a state in which a positively charged blocking agent is arranged on the surface of the sensor element shown in FIG. 6B.

When the blocking agent 40 is positively charged, a large amount of positively charged blocking agent 40 is adsorbed on the surface of the sensor element 10 on which few positively charged molecules 30 are arranged as shown in FIG. 8A, while a small amount of positively charged blocking agent 40 is adsorbed on the surface of the sensor element 10 on which many positively charged molecules 30 are arranged as shown in FIG. 8B. Therefore, the value of current flowing through the semiconductor layer 11 of the sensor element 10 is equalized. For example, the current value in FIG. 8A can be adjusted to I=5, while the current value in FIG. 8B can be adjusted to I=5

As described above, even when the blocking agent 40 is either negatively charged or positively charged, variation in charge on the surface of the sensor element 10 can be adjusted.

In addition, in FIG. 7A and FIG. 7B, the whole of the surface of the sensor element 10 is negatively charged by the negatively charged bocking agent 40, but the effect of increasing the sensitivity by the positively charged molecules 30 is exhibited immediately below the positively charged molecules 30 and thus has no problem. The same is true in FIG. 8A and FIG. 8B.

### Third Embodiment

In a sensor according to a third embodiment, positively charged molecules are modified on the surfaces of particles having a diameter of 10 nm or more and 10 μm or less.

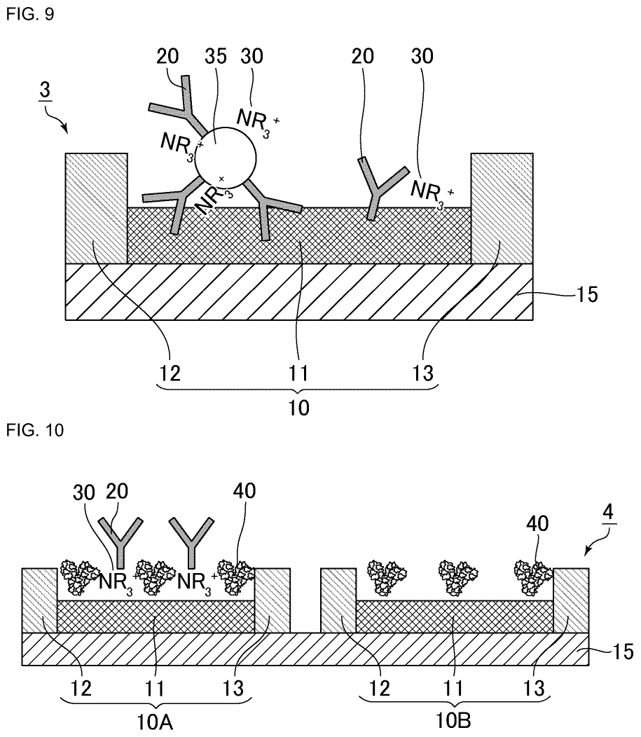

FIG. 9 is a schematic diagram showing an example of sensor according to the third embodiment.

As in a sensor 3 shown in FIG. 9, positively charged molecules 30 may be modified on the surfaces of particles 35 having a diameter of 10 nm or more and 10 μm or less. As shown in FIG. 9, the positively charged molecules 30 not modified on the surfaces of the particles 35 may be present on the surface of the sensor element 10. The expression “the positively charged molecules 30 are modified on the surfaces of particles 35” includes a case where the cationic functional group such as a NR₃⁺ group or the like is modified on the surface of the particles 35.

For example, the positively charged molecules 30 can be arranged on the surface of the sensor element 10 by dropping the particles 35 modified with the positively charged molecule 30 on the surface of the sensor element 10. In this case, the diameter of the particles 35 is 10 nm or more and 10 μm or less, and thus visibility is excellent, and control is facilitated.

Further, when the particles 35 modified with the positively charged molecules 30 are arranged on the surface of the sensor element 10, the positively charged molecules 30 are hardly separated from the surface of the sensor element 10 (for example, the surface of the semiconductor layer 11) as compared with when only the positively charged molecules 30 are arranged on the surface of the sensor element 10.

Also, the surface of the sensor element 10 is mechanically pressed by the particles 35, and thus the semiconductor layer 11 or the like constituting the sensor element 10 is hardly broken.

When the diameter of the particles 35 is smaller than 10 nm, handling becomes difficult. On the other hand, when the diameter of the particles 35 exceeds 10 μm, the surface density of the positively charged molecules 30 arranged on the surface of the sensor element 10 is not easily increased.

The diameter of the particles 35 can be measured by, for example, an optical microscope, a scanning electron microscope (SEM), an atomic force microscope (AFM), or the like.

Examples of the particles 35 include resin particles of polystyrene, latex, or the like, magnetic particles, and the like.

A commercial product may be used as the particles 35 whose surfaces are modified with the positively charged molecules 30. For example, micromer with surface charge manufactured by Micromod Inc. can be used as polystyrene particles whose surfaces are modified with NR₃⁺ group.

### Fourth Embodiment

A sensor according to a fourth embodiment includes a field effect transistor-type first sensor element, a field effect transistor-type second sensor element, and an insulating substrate, the first sensor element and the second sensor element being arranged on the insulating substrate. In this embodiment, the first sensor element can be used as a measurement sensor, and the second sensor element can be used as a reference sensor.

FIG. 10 is a schematic diagram showing an example of the sensor according to the fourth embodiment.

A sensor 4 shown in FIG. 10 includes a field effect transistor-type first sensor element 10A, a field effect transistor-type second sensor element 10B, and an insulating substrate 15, and the first sensor element 10A and the second sensor element 10B are arranged on the insulating substrate 15.

The probe molecules 20 and the positively charged molecules 30 are arranged on at least a portion of the surface of the first sensor element 10A. Although not shown in FIG. 10, the surfaces of particles 35 (refer to FIG. 9) having a diameter of 10 nm or more and 10 μm or less may be modified with the positively charged molecules 30.

As shown in FIG. 10, the probe molecules 20 and the positively charged molecules 30 may be arranged together with the blocking agent 40 on at least a portion of the surface of the first sensor element 10A. In addition, the blocking agent 40 is not necessarily arranged on the surface of the first sensor element 10A.

The first sensor element 10A includes, for example, a semiconductor layer 11, and a source electrode 12 and a drain electrode 13 electrically connected to the semiconductor layer 11. The semiconductor layer 11 between the source electrode 12 and the drain electrode 13 constitutes a channel of the sensor element 10.

The probe molecules 20 are not arranged on the surface of the second sensor element 10B. In the example shown in FIG. 10, the positively charged molecules 30 are also not arranged on the surface of the second sensor element 10B.

As shown in FIG. 10, when the blocking agent 40 is arranged on at least a portion of the surface of the first sensor element 10A, the blocking agent 40 may be arranged on at least a portion of the surface of the second sensor element 10B. On the other hand, when the blocking agent 40 is not arranged on the surface of the first sensor element 10A, the blocking agent 40 may not be arranged on the surface of the second sensor element 10B.

Besides the above, the configurations of the first sensor element 10A and the second sensor element 10B are common to the configuration of the sensor element 10.

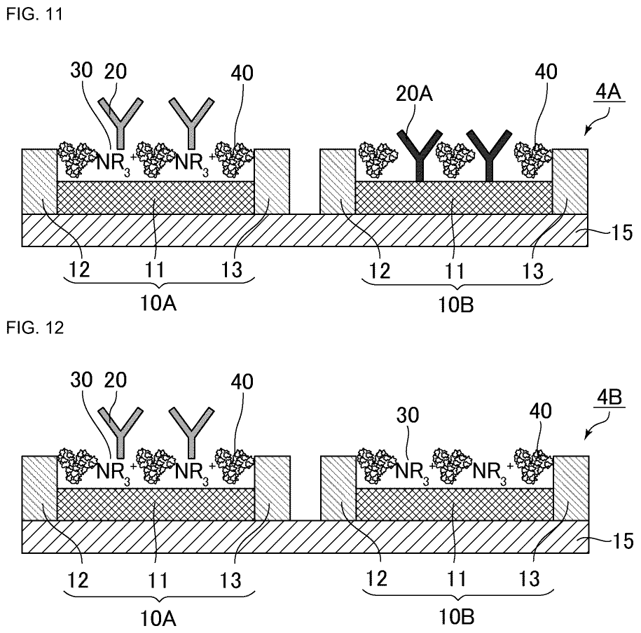

FIG. 11 is a schematic diagram showing a first modified example of the sensor according to the fourth embodiment.

In a sensor 4A shown in FIG. 11, probe molecules 20A other than the probe molecules 20 are arranged on at least a portion of the surface of the second sensor element 10B. The other configurations are common to the sensor 4 shown in FIG. 10.

FIG. 12 is a schematic diagram showing a second modified example of the sensor according to the fourth embodiment.

In a sensor 4B shown in FIG. 12, the positively charged molecules 30 are arranged on at least a portion of the surface of the second sensor element 10B. The other configurations are common to the sensor 4 shown in FIG. 10.

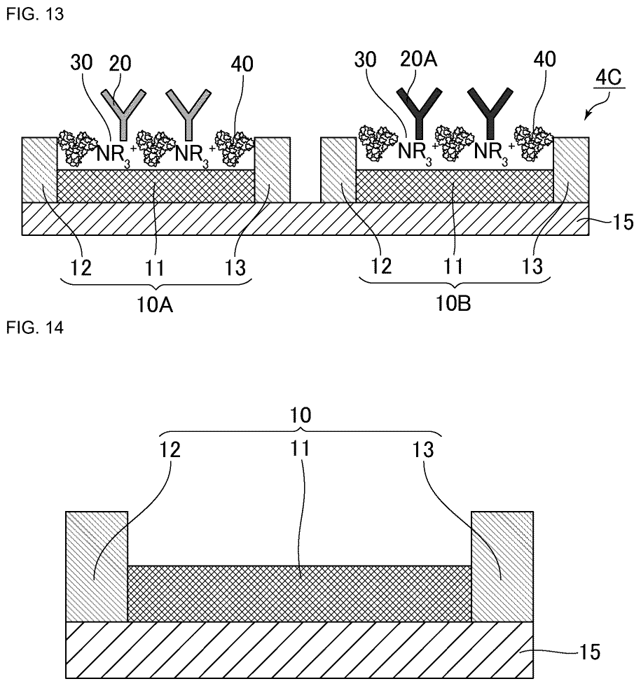

FIG. 13 is a schematic diagram showing a third modified example of the sensor according to the fourth embodiment.

In a sensor 4C shown in FIG. 13, probe molecules 20A other than the probe molecules 20 and the positively charged molecules 30 are arranged on at least a portion of the surface of the second sensor element 10B. The other configurations are common to the sensor 4 shown in FIG. 10.

When the first sensor element 10A whose surface charge is modulated with the positively charged molecules 30 is a used as a measurement sensor, in the sensor element, a noise component caused by non-specific adsorption is amplified to the same degree as a signal component caused by specific adsorption, and a total of the components is output. Therefore, when the second sensor element 10B, on whose surface the probe molecules 20 are not arranged but the positively charged molecules 30 are arranged, as shown in FIG. 12, is used as the reference sensor, the accuracy can be increased. For example, a difference between sensor outputs of the first sensor element 10A and the second sensor element 10B is determined, and a background change such as non-specific adsorption is removed. In this case, the S/N ratio is improved by decreasing a specified noise component while intensifying the signal component, thereby obtaining a high-accuracy sensor.

Also, when the positively charged molecules 30 are arranged on each of the first sensor elements 10A and the second sensor element 10B, the use of signal components enables the amount of specific adsorption to be estimated with high accuracy.

For example, when the positively charged molecules 30 are arranged on the first sensor element 10A, a signal component is generated, and a correlation is recognized between the amplitude of the signal component and the response of the sensor element after the positively charged molecules 30 are arranged. Therefore, the sensor response can be independently determined by measuring the signal component when the positively charged molecules 30 are arranged. Thus, when the surface density of the positively charged molecules 30 of each of the first sensor element 10A and the second sensor element 10B is intentionally changed or when the area densities unintentionally become different, the signal component in each of the cases is measured when the positively charged molecules 30 are arranged. This allows the responses of both sensor elements to be individually determined. When the responses of both sensor elements can be determined, the amount of charge adsorption of each of the sensor elements can be estimated from the signal component when a sample containing a substance to be detected is dropped on the sensor elements, and the amount of specific adsorption can be precisely estimated by calculating a difference between both amounts.

The sensor of the present disclosure is not limited to the embodiments described above, and various applications and modifications can be added to the configuration, production conditions, etc. of the sensor within the scope of the present disclosure.

For example, in the sensor of the present disclosure, an insulating coat layer may be provided on a portion other than a sensing portion of the sensor element. The insulation of a portion other than the sensing portion can be enhanced by providing the insulting coat layer, and thus the reliability of the sensor is improved. Also, the target molecules are not captured by a portion other than the sensing portion, thereby enhancing sensor sensibility.

Examples of a material constituting the insulating coat layer include organic compounds such as polyimide, an epoxy resin, an acrylic resin, a fluororesin, and the like; and the like. The thickness of the insulating coat layer may be 100 nm or more and 10 μm or less.

Alternatively, an insulating coat layer may be provided on the source electrode and the drain electrode, and a semiconductor layer may be disposed on the source electrode the drain electrode, and the insulating coat layer.

A method for detecting a substance to be detected in a solution using the sensor of the present disclosure is described below. The method is also one aspect of the present disclosure.

First, the substance to be detected in a solution is captured by the probe molecules using the sensor of the present disclosure.

For example, a sample containing the substance to be detected is supplied to the sensor. Thus, the sample is brought into contact with the sensor element. The sample containing the substance to be detected may be liquid. In this case, the sample may be dropped on the sensor element using a dropper or the like, or the sample may be introduced to the sensor element using a flow path.

Examples of the sample containing the substance to be detected include body fluids such as subject's saliva, throat swab, a nasal wash, a tear fluid, blood, and the like, biological samples such as urea, feces, and the like, a suspension of cells or virus itself, drinking water, sewage, exhalation, and the like.

Then, an electrical change caused by the substance to be detected in the sensor element is measured. When the sensor of the present disclosure includes the first sensor element and the second sensor element, an electrical change caused by the substance to be detected in each of the first sensor element and the second sensor element is measured.

Examples of an electrical physical quantity changed by the interaction between the substance to be detected and the probe molecules include a voltage value, a current value, frequency characteristics, an electrical resistance value, conductivity, and the like.

For example, when a voltage is applied between the source electrode and the drain electrode, a current value (drain current value) flowing between the source electrode and the drain electrode is measured. In this case, the gate voltage (also referred to as the “Dirac voltage V_{Dirac}” hereinafter) when the current value between the source and drain is minimized or a change over time thereof is obtained as an example of the sensor outputs.

When the sensor of the present disclosure includes the first sensor element and the second sensor element, an electrical change of the first sensor element and an electrical change of the second sensor element are compared with each other.

When both are compared with each other, for example, a difference between the sensor outputs, the ratios of the sensor outputs, or the like may be compared.

In the detection method of the present disclosure, a background may be measured by using a sample not containing the substance to be detected before the sample containing the substance to be detected is supplied to the sensor.

In measuring the background, the sample not containing the substance to be detected is removed from the sensor before the sample containing the substance to be detected is supplied to the sensor.

The present specification discloses the following contents.

<1>

A sensor for detecting a substance to be detected in a solution, the sensor including:
a field effect transistor-type sensor element; and
probe molecules and positively charged molecules arranged on at least a portion of the surface of the sensor element,
in which the positively charged molecules have a cationic functional group the charge state of which has no pH dependence.
   <2>

The sensor described in <1>, in which the sensor element contains graphene or carbon nanotubes.

<3>

The sensor described in <1>, in which the cationic functional group contains a NR₃⁺ group (Rs each independently represent an alkyl group or aryl group having 1 or more and 20 or less carbon atoms).

<4>

The sensor described in <2>, in which the cationic functional group contains a NR₃⁺ group (Rs each independently represent an alkyl group or aryl group having 1 or more and 20 or less carbon atoms).

<5>

The sensor described in any one of <1> to <4>, in which the cationic functional group contains a PR₃⁺ group (Rs each independently represent an alkyl group or aryl group having 1 or more and 20 or less carbon atoms).

<6>

The sensor described in any one of <3> to <5>, in which at least one of Rs is a methyl group.

<7>

The sensor described in any one of <1> to <6>, in which the cationic functional group is arranged with a surface density of 5×10⁻² C/m² or less on the surface of the sensor element.

<8>

The sensor described in any one of <1> to <7>, in which a blocking agent is arranged together with the probe molecules and the positively charged molecules on at least a portion of the surface of the sensor element.

<9>

The sensor described in any one of <1> to <8>, in which the positively charged molecules are modified on the surfaces of particles having a diameter of 10 nm or more and 10 μm or less.

<10>

The sensor described in any one of <1> to <9>,
in which the sensor element is a first sensor element; and
the sensor further includes a field effect transistor-type second sensor element and an insulating substrate;
the first sensor element and the second sensor element are disposed on the insulating substrate; and
the probe molecules are not arranged on the second sensor element.
   <11>

A detection method including:
a step of capturing a substance to be detected in a solution by the probe molecules using the sensor described in any one of <1> to <9>; and
a step of measuring an electrical change caused by the substance to be detected in the sensor element.
   <12>

A detection method including:
a step of capturing a substance to be detected in a solution by the probe molecules using the sensor described in <10>;
a step of measuring an electrical change caused by the substance to be detected in each of the first sensor element and the second sensor element; and
a step of comparing the electrical change of the first sensor element with the electrical change of the second sensor element.

### Examples

Described below are examples more specifically disclosing the sensor and the detection method of the present disclosure and are not limited thereto.

### (1) Formation of Sensor Element

FIG. 14 is a schematic diagram showing an example a sensor element formed on an insulating substrate.

As shown in FIG. 14, a sensor element 10 is formed by forming a semiconductor layer 11, a source electrode 12, and a drain electrode 13 on an insulating substrate 15. (Refer to, for example, Ushiba, S.; Nakano, T.; Miyakawa, N.; Shinagawa, A.; Ono, T.; Kanai, Y.; Tani, S.; Kimura, M.; Matsumoto, K., “Robust Graphene Field-Effect Transistor Biosensors via Hydrophobization of SiO2 Substrates”, Appl. Phys. Exp., 15, 115002 (2022) etc.)

FIG. 14 shows a state in which one sensor element 10 is formed on the insulating substrate 15, but plural sensor elements 10 are actually formed on the insulating substrate 15.

### (2) Arrangement of Probe Molecules and Positively Charged Molecules on Sensor Element

First, positively charged molecules are prepared. For example, polystyrene particles (micromer 01-05-103 manufactured by Micromod Inc.) whose surfaces are modified with NR₃⁺ group are prepared. The particles are dispersed in water and have a solid content concentration of about 50 mg/mL and a particle diameter of 1 μm.

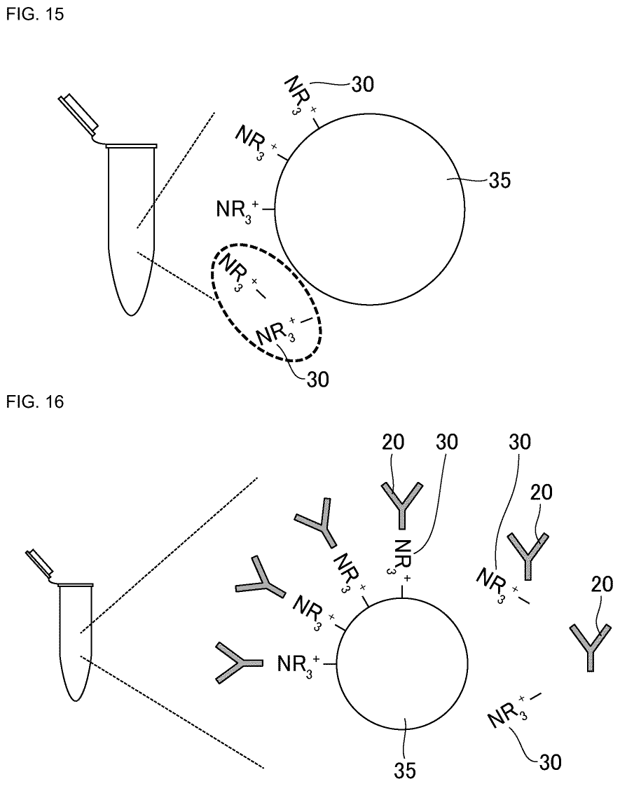

FIG. 15 is a schematic diagram showing an example of the positively charged molecules.

As shown in FIG. 15, many of the positively charged molecules 30 are modified on the surfaces of the particles 35. It is supposed that as shown by circling with a broken line in FIG. 15, the positively charged molecules 30 isolated from the particles 35 are also present in a solution.

In addition, when the particles 35 are not required, the solution is removed by a method such as centrifugal separation or the like, and the positively charged molecules 30 contained in the supernatant may be used. Alternatively, N(CH₃)₄⁺ (tetramethyl ammonium ion or N(CH₃CH₂)₄⁺ (tetraethyl ammonium ion) may be used.

The probe molecules are separately prepared. For example, an antibody solution (Anti-CRP, 7.6 μM) is prepared.

A solution (5 mg/mL) of polystyrene particles having NR₃⁺ group-modified surfaces and an antibody solution (Anti-CRP, 7.6 μM) are mixed at 1:1 and allowed to stand for 30 minutes. As a result, polystyrene particles whose surfaces are modified with the NR₃⁺ group and antibody are obtained.

FIG. 16 is a schematic diagram showing an example probe molecules present together with positively charged molecules.

It is supposed that as shown in FIG. 16, probe molecules 20 and positively charged molecules 30 below are present in the solution obtained by mixing.
(a) The probe molecules 20 adsorbed on the particles 35
(b) The probe molecules 20 not adsorbed on either the particles 35 or the positively charged molecules 30
(c) The probe molecules 20 adsorbed on the isolated positively charged molecules 30 but not adsorbed on the particles 35
(d) The positively charged molecules 30 isolated from the particles 35 but not adsorbed on the probe molecules 20

The solution obtained by mixing is dropped on the sensor element and allowed to stand for 30 minutes, and then washed with 1.5 mmol/L phosphorate-buffered saline (PBS). Consequently, the probe molecules and the positively charged molecules are arranged on the surface of the sensor element.

In this case, a rubber pool is attached to divide the plural sensor elements on the insulating substrate into a first sensor element and a second sensor element. Then, the probe molecules and the positively charged molecules are arranged on the surface of the first sensor element, and neither the probe molecules nor the positively charged molecules are arranged on the surface of the second sensor element.

In the method described above, the solution containing the positively charged molecules and the solution containing the probe molecules are mixed and reacted and then arranged on the surface of the sensor element. However, for example, the positively charged molecules may be arranged on the surface of the sensor element using the solution containing the positively charged molecules and then washed. Then, the probe molecules may be arranged on the surface of the sensor element using the solution containing the probe molecules and then washed.

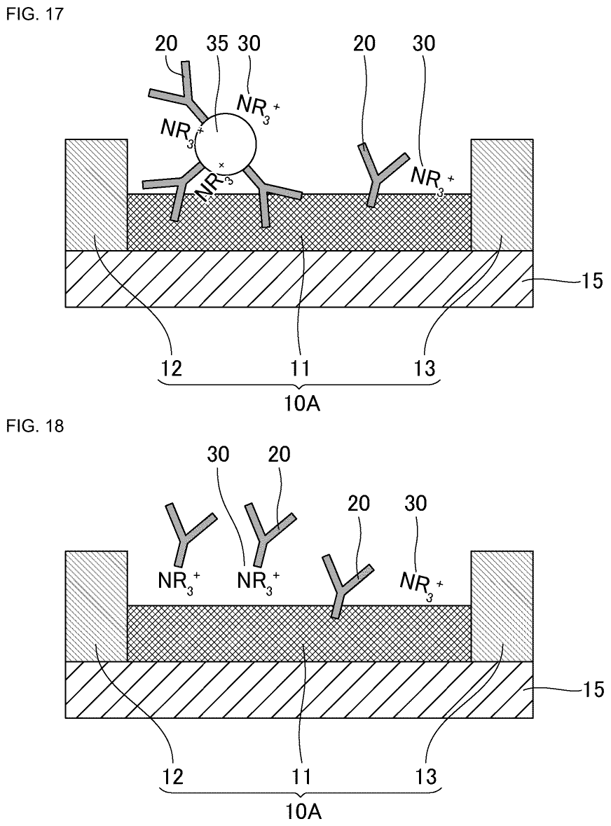

FIG. 17 is a schematic diagram showing an example of a first sensor element on whose surface probe molecules and positively charged molecules are arranged.

In the example shown in FIG. 17, in addition to the particles 35 whose surfaces are modified with the probe molecules 20 and the positively charged molecules 30, the probe molecules 20 and the positively charged molecules 30 which are not modified on the surfaces of the particles 35 are arranged on the surface of the first sensor element 10A. The probe molecules 20 may be modified with the positively charged molecules 30, but is not necessarily modified with the positively charged molecules 30.

In addition, the substance to be detected which is captured at a position apart from the semiconductor layer 11 (for example, a position at a distance of 30 nm or more) is not easily detected by the first sensor element 10A. Therefore, the substance to be detected which is captured by the probe molecules 20 located near the interface between the particles 35 and the semiconductor layer 11 is detected.

FIG. 18 is a schematic diagram showing another example of the first sensor element on whose surface the probe molecules and the positively charged molecules are arranged.

In the example shown in FIG. 18, the probe molecules 20 and the positively charged molecules 30, which are not modified on the particles 35, are arranged on the surface of the first sensor element 10A. As shown in FIG. 18, the probe molecules 20 may be modified with the positively charged molecules 30, but is not necessarily modified with the positively charged molecules 30.

### (3) Blocking for Non-Specific Suppression

A blocking agent is arranged on the surface of the sensor element. For example, 1% BSA is dropped on the sensor element and allowed to stand for 30 minutes, and then washed. In this case, the blocking agent is arranged on the surfaces of both the first sensor element and the second sensor element.

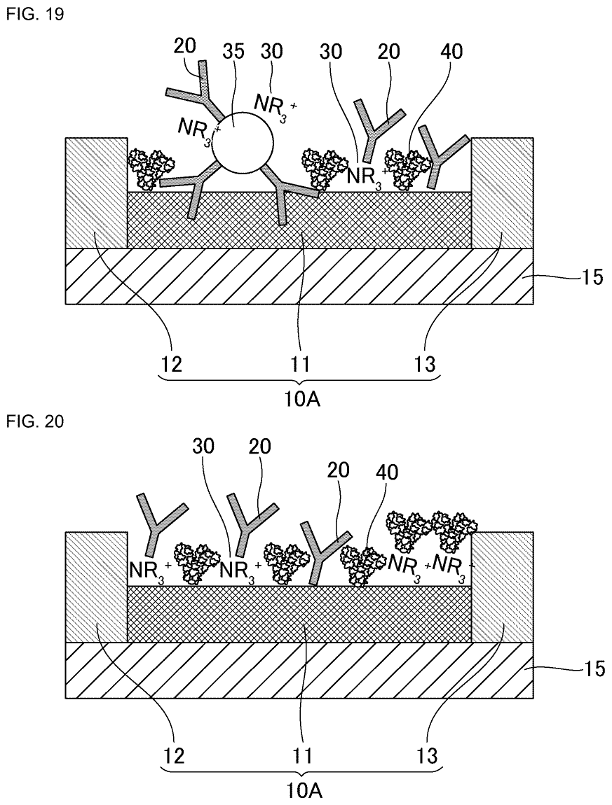

FIG. 19 is a schematic diagram showing an example of the first sensor element on whose surface the blocking agent is arranged. FIG. 20 is a schematic diagram showing another example of the first sensor element on whose surface the blocking agent is arranged.

In the example shown in FIG. 19, the blocking agent 40 is arranged on the surface of the first sensor element 10A shown in FIG. 17. In the example shown in FIG. 20, the blocking agent 40 is arranged on the surface of the first sensor element 10A shown in FIG. 18.

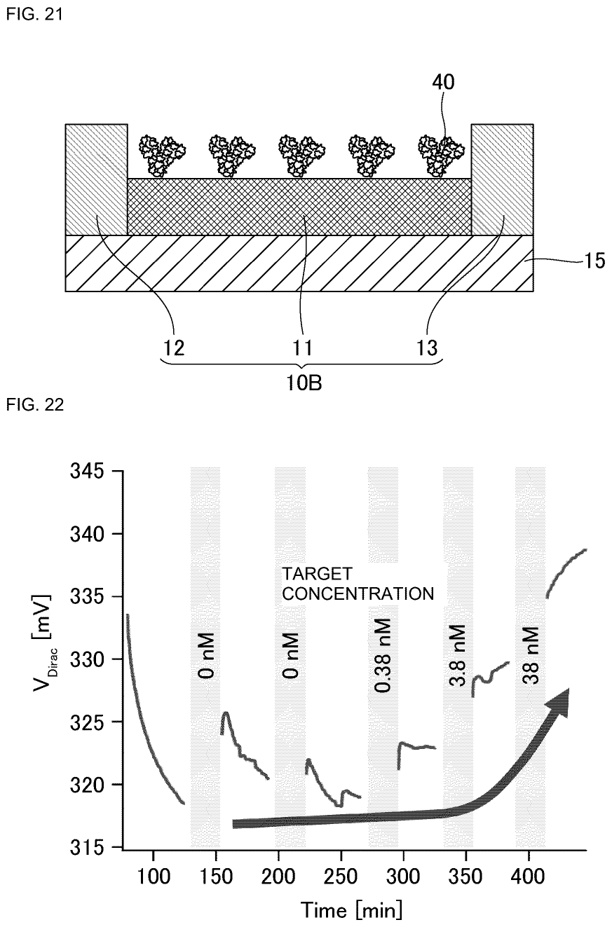

FIG. 21 is a schematic diagram showing an example of the second sensor element on whose surface the blocking agent is arranged.

In the example shown in FIG. 21, the probe molecules 20 and the positively charged molecules 30 are not arranged on the surface of the second sensor element 10B, and only the blocking agent 40 is arranged.

### (4) Detection Results of Antigen-Antibody Reaction

First, C-reactive protein (CRP) serving as the substance to be detected was detected by using only the first sensor element 10A shown in each of FIG. 19 and FIG. 20. That is, noise was not cancelled by the second sensor element 10B shown in FIG. 21.

FIG. 22 is a graph showing an example of the detection results when only the first sensor element was used.

FIG. 22 indicates that the Dirac voltage V_{Dirac} is increased depending on the target concentration as the concentration of the substance to be detected. Therefore, it is found that CRP as the substance to be detected can be detected. As described above, the Dirac voltage represents the gate voltage when the current value between the source and the drain is minimized.

The graph shown in FIG. 22 shows the average value of the outputs of the first sensor element 10A shown in FIG. 19 and FIG. 20. However, the output of the first sensor element 10A shown in FIG. 19 and the output of the first sensor element 10A shown in FIG. 20 have the same tendency even when individually viewed, and thus the influence of the magnitude of adsorption amount of the particles 35 on the response quantity is considered to be small.

Next, CRP serving as the substance to be detected was detected by using the first sensor element 10A shown in each of FIG. 19 and FIG. 20 and the second sensor element 10B shown in FIG. 21. That is, the first sensor elements 10A shown in FIG. 19 and FIG. 20 were used as measurement sensors, and the second sensor element 10B shown in FIG. 21 was used as a reference sensor.

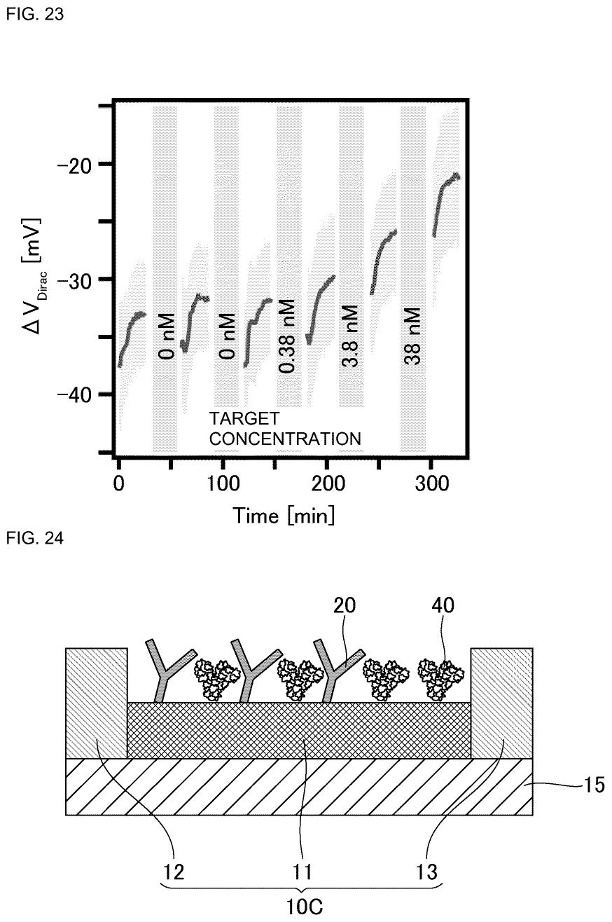

FIG. 23 is a graph showing an example of detection results when the first sensor element and the second sensor element were used.

FIG. 23 indicates that a difference ΔV_{Dirac} in Dirac voltage is increased depending on the target concentration. It is thus found that CRP as the substance to be detected can be detected.

FIG. 23 shows the result of subtraction the average value of output of the second sensor element 10B shown in FIG. 21 from the average value of outputs of the first sensor elements 10A shown in FIG. 19 and FIG. 20.

Further, in order to verify the effect by the positively charged molecules 30, CRP as the substance to be detected was detected by using, as a measurement sensor, a third sensor element on whose surface the positively charged molecules 30 were not arranged. Specifically, the third sensor element and the second sensor element were formed in place of the first sensor element and the second sensor element on the insulating substrate.

FIG. 24 is a schematic diagram showing an example of the third sensor element on whose surface the positively charged molecules 30 are not arranged.

In the example shown in FIG. 24, the positively charged molecules 30 are not arranged on the surface of the third sensor element 10C, and the probe molecules 20 and the blocking agent 40 are arranged.

CRP was detected by using the third sensor element 10C shown in FIG. 24 and the second sensor element 10B shown in FIG. 21.

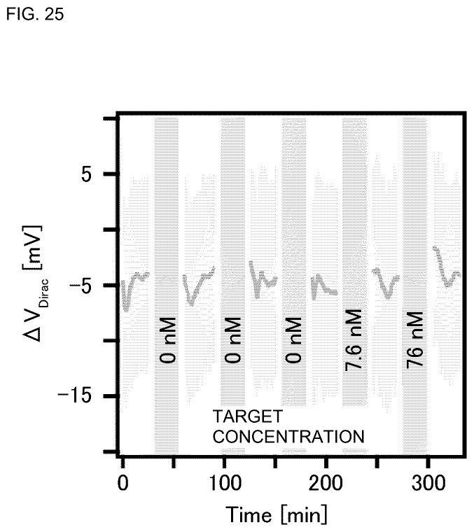

FIG. 25 is a graph showing an example of detection results when the third sensor element and the second sensor element were used.

FIG. 25 indicates that a difference ΔV_{Dirac} in Dirac voltage is substantially constant regardless of increases in the target concentration. It is thus found the sensor does not respond.

It is considered from the above results that the sensitivity of the sensor is increased by the positively charged molecules having a cationic functional group such as a NR₃⁺ group or the like.

### REFERENCE SIGNS LIST

1, 2, 3, 4, 4A, 4B, 4C sensor
10 sensor element
10A first sensor element
10B second sensor element
10C third sensor element
11 semiconductor layer
12 source electrode
13 drain electrode
15 insulating substrate
20, 20A probe molecule
30 positively charged molecule
35 particle
40 blocking agent
50 gate electrode
51 pool
52 electrolytic solution
53 substance to be detected (target molecule)

1. A sensor for detecting a substance to be detected in a solution, the sensor comprising:
a field effect transistor-type sensor element; and
probe molecules and positively charged molecules arranged on at least a portion of the surface of the sensor element,
wherein the positively charged molecules have a cationic functional group the charge state of which has no pH dependence.

2. The sensor according to claim 1, wherein the sensor element contains graphene or carbon nanotubes.

3. The sensor according to claim 2, wherein the positively charged molecules are arranged on the surface of the sensor element containing graphene or carbon nanotubes via non-covalent bonds.

4. The sensor according to claim 1, wherein the cationic functional group contains a NR₃⁺ group (Rs each independently represent an alkyl group or aryl group having 1 or more and 20 or less carbon atoms).

5. The sensor according to claim 2, wherein the cationic functional group contains a NR₃⁺ group (Rs each independently represent an alkyl group or aryl group having 1 or more and 20 or less carbon atoms).

6. The sensor according to claim 1, wherein the cationic functional group contains a PR₃⁺ group (Rs each independently represent an alkyl group or aryl group having 1 or more and 20 or less carbon atoms).

7. The sensor according to claim 3, wherein at least one of Rs is a methyl group.

8. The sensor according to claim 1, wherein the cationic functional group is arranged with a surface density of 5×10⁻² C/m² or less on the surface of the sensor element.

9. The sensor according to claim 1, wherein a blocking agent is arranged together with the probe molecules and the positively charged molecules on at least a portion of the surface of the sensor element.

10. The sensor according to claim 9, wherein the blocking agent is arranged on the surfaces of both the first sensor element and the second sensor element.

11. The sensor according to claim 1, wherein the positively charged molecules are modified on the surfaces of particles having a diameter of 10 nm or more and 10 μm or less.

12. The sensor according to claim 1,
wherein the sensor element is a first sensor element,
the sensor further includes a field effect transistor-type second sensor element and an insulating substrate;
the first sensor element and the second sensor element are disposed on the insulating substrate; and
the probe molecules are not arranged on the second sensor element.

13. The sensor according to claim 12, wherein the positively charged molecules are also arranged on the surface of the second sensor element.

14. The sensor according to claim 12, wherein other probe molecules, different from the probe molecules, are arranged on the surface of the second sensor element.

15. The sensor according to claim 1, wherein the charge state of the cationic functional group is constant within a pH range of 2 to 12.

16. A detection method comprising:
capturing a substance to be detected in a solution by the probe molecules using the sensor according to claim 1; and
measuring an electrical change caused by the substance to be detected in the sensor element.

17. A detection method comprising:
capturing a substance to be detected in a solution by the probe molecules using the sensor according to claim 12;
measuring an electrical change caused by the substance to be detected in each of the first sensor element and the second sensor element; and
comparing the electrical change of the first sensor element with the electrical change of the second sensor element.

18. The detection method according to claim 17, wherein comparing the electrical change includes calculating a difference between a sensor output from the first sensor element and a sensor output from the second sensor element.

19. A method for manufacturing a sensor for detecting a substance in a solution, the method comprising:
providing a field effect transistor-type sensor element comprising a semiconductor layer between a source electrode and a drain electrode; and
arranging probe molecules and positively charged molecules on at least a portion of a surface of the sensor element,
wherein the positively charged molecules have a cationic functional group having a charge state that is constant over a pH range of 2 to 12.

20. The method according to claim 19, wherein arranging the probe molecules and the positively charged molecules includes:
mixing a first solution containing the probe molecules with a second solution containing the positively charged molecules to form a mixture; and
applying the mixture to the surface of the sensor element.
